(19) United States
(12) Patent Application Publication
(10) Pub. No.: US 2022/0398870 A1
(43) Pub. Date: Dec. 15, 2022

(54) METHODS AND SYSTEMS FOR FACILITATING COLLECTION OF ROAD USER CHARGES USING A DIGITAL CURRENCY BASED ON A DISTRIBUTED LEDGER TECHNOLOGY

(71) Applicant: Taylor William Paul Lochrane, Washington, DC (US)

(72) Inventor: Taylor William Paul Lochrane, Washington, DC (US)

(21) Appl. No.: 17/829,748

(22) Filed: Jun. 1, 2022

Related U.S. Application Data
(60) Provisional application No. 63/209,109, filed on Jun. 10, 2021.

(51) Int. Cl. G07B 15/06; G06Q 20/06; G06Q 20/38; G06Q 20/36

(52) U.S. Cl. CPC G07B 15/063; G06Q 20/0658; G06Q 20/389; G06Q 20/3678

(57) ABSTRACT

A system and a method for facilitating the collecting of the Road Use Charges (RUC) using a digital currency based on a Distributed Ledger Technology (DLT) network is disclosed. The method includes processing the Road User data and Facility Owner data to generate user accounts on the Road Ledger℠, a DLT network, receiving Road User data from at least one Road User device, receiving position and distance data from at least one input device, receiving cost data from at least one Facility Owner device, analyzing data to generate a transaction(s) in the form of a policy and a smart contract, and adding the Trip Coin℠ Digital Currency (TCDC) corresponding to the payment alert to the digital wallet of the user, by a processing device on the Road Ledger℠, a DLT network. Further, method includes transferring TCDC to Facility Owners digital wallets for RUC using Road Ledger℠, using a storage device.

### FIELD OF THE INVENTION

The present invention relates generally to data processing. More specifically, the present invention includes methods and systems for facilitating the collection of a Road User Charges (RUC) using a digital currency based on a Distributed Ledger Technology (DLT).

### BACKGROUND OF THE INVENTION

The field of data processing is technologically important to several industries, business organizations and individuals.

Today in the US and around the world, a combination of federal, state, and local tax is collected to fund roads and highways through a petroleum-powered motor fuel tax, also known as the “gas tax.” As different alternative fuels emerge for vehicles (e.g., biodiesel, electricity, ethanol, hydrogen, natural gas, propane, etc.), no system is in place to collect motor fuel tax from vehicles not using a petroleum-powered energy source. Existing techniques for facilitating collecting road use fees are deficient with regard to several aspects. For instance, current technologies do not facilitate collecting motor fuel tax from vehicles not using a petroleum-powered energy source. Furthermore, current technologies do not collect road fees (or tax) using a digital currency normalized for vehicles using any energy source. Therefore, there is a need for improved methods and systems for facilitating the collecting of the Road User Charges (RUC) (also known as Vehicle Miles Traveled (VMT); Mileage-Based User Fee (MBUF); Road-User Charges; Road-use Charges, etc.) using a digital currency based on a Distributed Ledger Technology (DLT) network that may overcome one or more of the above-mentioned problems and limitations.

An objective of the present invention is to provide a method and system for facilitating the collection of a road use fee using a digital currency based on a distributed ledger technology.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for facilitating the collecting of the Road User Charges (RUC) using a digital currency based on Distributed Ledger Technology (DLT) is disclosed.

Accordingly, the method may include receiving, using a communication device, entity data from at least one entity device associated with the at least one entity. The entity may comprise a Road User and a Facility Owner.

Further the method comprises processing, using a processing device, the entity data to generate an entity account. The entity account may comprise a Road User account and a Facility Owner account.

Further, the method comprises retrieving, using a storage device, a digital currency (i.e., coins and tokens) referred to as Trip Coin℠ Digital Currency (TCDC) to a Road User digital wallet from at least one of a fueling station and a Trip Exchange platform.

Further, the method comprises analyzing, using the processing device, data from an RUC Application to generate a transaction in the form of at least one of a policy and a smart contract, on a DLT network, referred to as the Road Ledger℠ Further, the method comprises transmitting, using the communication device, the transaction in the form of the policy and a smart contract to the at least one Road User device and the at least one Facility Owner device through the Road Ledger℠, a DLT network.

Further, the method comprises adding, using the processing device, the TCDCs to a facility digital wallet of the Facility Owner account based on the policy and a smart contract to generate a transfer alert.

Furthermore, the method comprises storing, using the storage device, the policy and the smart contract, a payment alert, and the transfer alert on the Road Ledger℠, a DLT network.

According to some aspects, a system for facilitating the collecting of the RUC using a digital currency based on DLT is disclosed.

Accordingly, the system may include a communication device configured for receiving entity data from at least one entity device and account/address associated with the at least one entity.

Further, the communication device may be configured for receiving position and distance data from at least one input device.

Further, the communication device may be configured for receiving cost data for at least one Facility (i.e., roadway, toll road, etc.) and an account/address associated with at least one Facility Owner.

Further, the communication device may be configured for transmitting a transaction(s) in the form of a policy and a smart contract on the Road Ledger℠, a DLT network.

Further, the communication device may be configured for receiving a payment alert based on the policy and a smart contract from the at least one Road User device and account/address on the Road Ledger℠, a DLT network

Further, the communication device may be configured for transmitting a transfer alert to at least one of the at least one Road User device and account/address and the at least one Facility Owner device and account/address on the Road Ledger℠, a DLT network.

Further, the system may include a processing device configured for processing the user data to generate a user account.

Further, the processing device may be configured using a RUC Application for analyzing the position and distance data, the digital map data, and cost data from the RUC Rates database, based on the Trip Calculator to generate the transaction(s) in the form of a policy and a smart contract in the Contract Manager on the Road Ledger℠, a DLT network.

Further, the processing device may be configured for adding the TCDC corresponding to the payment alert for RUC to the digital wallet of the Road User on the Road Ledger℠, a DLT network.

Further, the processing device and account/address may be configured for adding the TCDC to a facility digital wallet of a Facility Owner account/address based on the policy and a smart contract to generate the transfer alert for RUC on the Road Ledger℠ a DLT network

Further, the system may include a storage device and account/address configured for retrieving the Coin Manager data including cost values from the RUC Rates database, Trip Manager data including the digital map data, and Trip Calculator data.

Further, the storage device may be configured for retrieving the RUC pricing model from RUC Rates database.

Further, the storage device may be configured for storing the user data, the user account, the distance data, the cost data, the policy and a smart contract, the payment alert, the transfer alert on the Road Ledger℠, a DLT network.

Further, the system may provide data to an Approved Designated Location (ADL) for transfer of TCDC from Road User to a facility digital wallet of a Facility Owner account/address based on the policy and a smart contract to generate the transfer alert for RUC on the Road Ledger℠, a DLT network

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart depicting an overall process for the method of the present invention.

FIG. 2 is a block diagram of a system for facilitating the collecting of the RUC using a digital currency, referred to as TCDC, based on a DLT network, in accordance with some embodiments.

FIG. 3 is a schematic of a system for facilitating collecting RUC by the exchange of fiat currency and other digital currency, referred to as TCDC, on the Trip Exchange platform and transferring TCDC between Road Users and Facility Owners based on the Road Ledger℠, a DLT network, in accordance with some embodiments.

FIG. 4 is a flow diagram of a method for facilitating adding TCDC to the digital wallet at a fueling station and a Trip Exchange platform, in accordance with some embodiments.

FIG. 5 is a flow diagram of a method for facilitating generating transaction(s) of TCDC in the form of policies and smart contracts to the Road Ledger℠, a DLT network, for facilitating the collecting of the RUC, in accordance with some embodiments.

FIG. 6 is a flowchart depicting a subprocess for a method for receiving cost data, position and distance data etc. from associated devices, according to the present invention.

FIG. 7 is a flow diagram of a method for facilitating and generating TCDC based on Facility Owners for each roadway used during a Road User trip determined by segments for facilitating the collecting of the RUC using the Road Ledger℠, a DLT network, in accordance with some embodiments.

FIG. 8 is a flowchart depicting a subprocess for a method for receiving, adding and transmitting TCDCs associated with a payment, according to the present invention.

FIG. 9 is a flow diagram of a method for facilitating generating transaction(s) of TCDC by segments of a trip based on Facility Owners for facilitating the collecting of the RUC using the Road Ledger℠, a DLT network, in accordance with some embodiments.

FIG. 10 is a flow diagram of a method for facilitating RUC at an Approved Designated Location (ADL), in accordance with some embodiments.

FIG. 11 is a schematic of a system for facilitating the collecting of the RUC using a digital currency, referred to as TCDC, based on a DLT network, in accordance with some embodiments.

FIG. 12 is an illustration of an online platform consistent with various embodiments of the present disclosure.

FIG. 13 is a block diagram of a computing device for implementing the methods disclosed herein, in accordance with some embodiments.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating the collecting of the Road User Charges (RUC) using a digital currency (i.e. coins or tokens) referred to as Trip Coin℠ Digital Currency (TCDC) using a Distributed Ledger Technology (DLT) network (includes, but not limited to, using a Directed Acyclic Graph known as a “Tangle”, a Hyperledger, and Blockchain, etc.) referred to as Road Ledger℠, embodiments of the present disclosure are not limited to use only in this context.

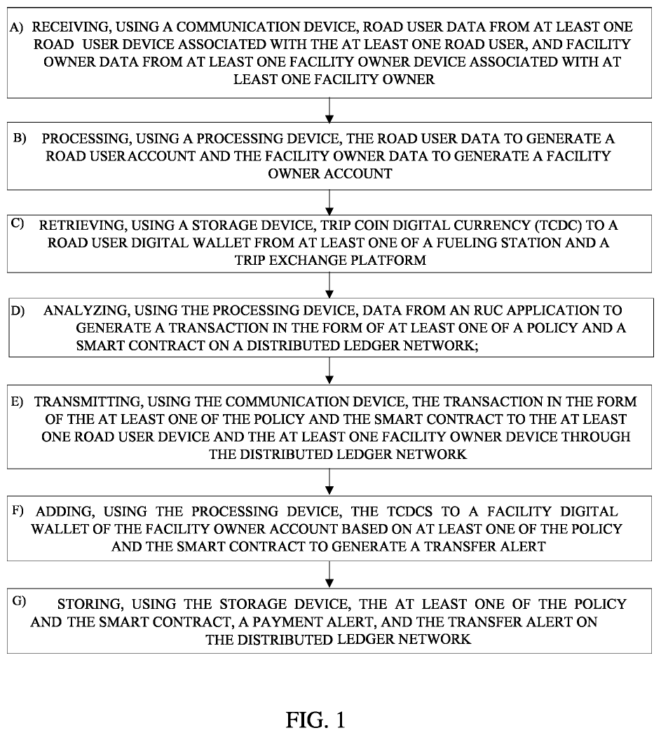

The following description is in reference to FIG. 1 through FIG. 13. As can be seen in FIG. 1 through FIG. 13, the present invention describes methods and systems for facilitating collecting a RUC using digital currency based on DLT.

As seen in FIG. 1 through FIG. 13 the system used to execute the method of the present invention allows the present invention to function as a communication tool between multiple users. To accomplish that, an overall method of operation of the present invention comprises receiving, using a communication device, Road User data from at least one Road User device associated with at least one Road User and Facility Owner data from at least one Facility Owner device associated with at least one Facility Owner (step A). Preferably, the communication device may be any electronic device that can connect to the DLT network through a wireless communication module. Examples of which include, but are not limited to Wi-Fi, on-board unit (OBU), dedicated short range communications (DSRC), cellular vehicle-to-everything (CV2X), cellular communications (4G, LTE, 5G, 6G), next generation cellular and wireless, satellite communications, radio frequency identification (RFID), etc. The at least one Road User may include an individual, an institution, or an organization that may want to pay the RUC (or road tax) for driving a vehicle on a road. Further, the vehicle may be associated with a vehicle type such as passenger vehicles, trucks, buses, motorcycle, etc. For example, the at least one Road User may include a vehicle driver, and the at least one Road User device may include on-board vehicle device such electronic control units (ECU), telematic systems, connected vehicle (CV) platforms, automated driving system (ADS) platforms, cooperative automated driving system (CADS) platforms, and etc., and a mobile device such as laptop, a smartphone, a tablet, a personal computer, etc. Further, the at least one Facility Owner device may include on-prem desktop computers, server computers and centralized and decentralized servers such cloud, fog and edge computing services. Further, the Facility Owner devices may include Intelligent Transportation Systems (ITS) and Information Technology (IT) systems which may use RUC Communication, ITS Roadside Equipment, Broadband Connectivity, etc. to connect to the Road Ledger℠, a DLT network.

The overall method of the present invention continues by processing, using a processing device, the Road User data to generate a Road User account and the Facility Owner data to generate a Facility Owner account (step B). The Road User account and the Facility Owner account may include a digital wallet, a unique user ID such as but not limited to decentralized identity, etc.

Further, the overall method may comprise retrieving, using a storage device, Trip Coin℠ Digital Currency (TCDC) to a Road User digital wallet from at least one of a fueling station and a Trip Exchange platform (step C). According to the preferred embodiment, the Trip Exchange platform may be used to convert fiat currency to digital currency, or to create TCDC (i.e., coins and tokens) etc. Preferably, the TCDC is calculated based on RUC pricing from the RUC Rates database which could be centralized and decentralized using a DLT network. Preferably, the RUC Rates database is updated and maintained by Facility Owners, based on each road facility referred to as a segment, and host the cost data and may include different pricing models such as stable pricing, variable pricing, and dynamic pricing based on distance of travel, type of vehicle and other system level attributes. A digital wallet is an electronic device, software or online service that holds digital currency (i.e., coins and tokens) with values associated with fiat currency for transaction between individuals or business

Furthermore, the system analyzes data from an RUC Application to generate a transaction in the form of at least one of a policy and a smart contract on a DLT network using the processing device (step D). In the preferred embodiment, data from the RUC Application comprises distance data, cost data and other input data based on a Trip Manager and a digital map. The digital map may include a geographical representation of a locality (such as city, province, country and, etc.). Further, the digital map may include details of the Facility Owner associated with the roadway. Thus, the policy and a smart contract may include different kinds of data, examples of which include, but are not limited to total distance traveled, a total cost of the segment and other data relevant for a trip. Accordingly, the total cost may be associated with TCDC, and the amount of the TCDC may be equivalent to the total cost of the trip.

Continuing with the preferred embodiment, the overall method continues by transmitting the transaction in the form of the at least one policy and a smart contract to the at least one Road User device and the at least one Facility Owner device through the Road Ledger℠, a DLT network, using the communication device (step E). The at least one Facility Owner may include an individual, an institution, and an organization that may be authorized to collect the RUC (or road tax). For example, the at least one Facility Owner may include a government roadway authority and other private operators. Further, the at least one Facility Owner device may include on-prem desktop computers, server computers and centralized and decentralized servers such cloud, fog and edge computing services. Furthermore, the cost data may include a cost for each vehicle type and distance based on different pricing models such as stable pricing, variable pricing, and dynamic pricing based on distance of travel, type of vehicle and other system level attributes for each roadway segment and associated with the Facility Owner.

Subsequently, the overall method may comprise adding the TCDC to a facility digital wallet of a Facility Owner account based on the policy and a smart contract to generate a transfer alert, using the processing device (step F). The Facility Owner account may be associated with the at least one Facility Owner, and the transfer alert may notify the at least one Facility Owner of receiving of the TCDC corresponding to the policy and a smart contract on the distributed ledger network. Subsequently, the overall method comprises storing, at least one of the policy and a smart contract, a payment alert, and the transfer alert on the distributed ledger network using the storage device (step G). The payment alert may include a consent and be fully automated from the at least one Road User to pay for the total cost. Further, the receiving of the payment alert may include receiving of funds (or fiat money, coins, tokens and, etc.) equivalent to the total cost. Furthermore, an amount of the TCDC may be equivalent to the total cost of the trip, and the trip may include a plurality of segments. To that end, the total cost may include a cost for each segment of the plurality of segments, and each segment may include a roadway associated with a Facility Owner.

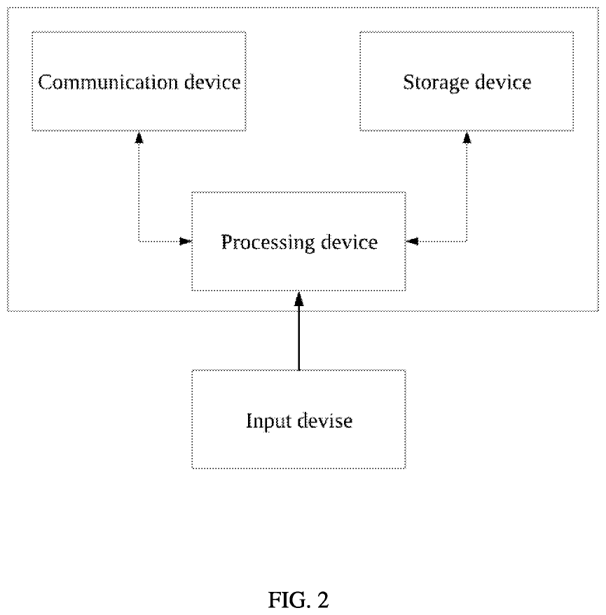

In reference to FIG. 2, a block diagram of a system for facilitating the collecting of the RUC using a digital currency, referred to as TCDC, based on a DLT network, in accordance with some embodiments is illustrated. Accordingly, the system may include the communication device configured for receiving Road User data from at least one Road User device associated with the at least one Road User. Preferably, the communication device may be any electronic device that can connect to the distributed ledger network through a wireless communication module. Examples of which include, but are not limited to Wi-Fi, on-board unit (OBU), dedicated short range communications (DSRC), cellular vehicle-to-everything (CV2X), cellular communications (4G, LTE, 5G, 6G), next generation cellular and wireless, satellite communications, radio frequency identification (RFID), etc. Accordingly, the functionalities of the communication device may comprise the following. The communication device may be configured for receiving distance data from at least one input device. Preferably, the input device may include a smart dashboard module both removable and integrated onboard a vehicle operating system, the vehicle that may be disposed on the vehicle of the at least one Road User. In an embodiment, the input device may include the at least one Road User device. Further, the communication device may be configured for receiving cost data from at least one Facility Owner device and account/address associated with the at least one Facility Owner. Further, the communication device may be configured for transmitting a transaction(s) in the form of the policy and a smart contract on the Road Ledger℠, a DLT network. Further, the communication device may be configured for receiving a payment alert based on the policy and a smart contract from the at least one Road User device. Furthermore, the communication device may be configured for transmitting a transfer alert to at least one of the at least one Road User device and the at least one Facility Owner device and account/address.

In the preferred embodiment, the processing device of the system comprises a Coin Manager associated with a RUC Application (an exemplary embodiment of a software platform associated with the disclosed system). Accordingly, the functionalities of the processing device may comprise the following. The processing device is configured for processing the Road User data to generate the Road User account, and the Facility Owner data to generate Facility Owner account. Further, the processing device may be configured for analyzing the position and distance data, the digital map data, RUC Rates, and the cost data based on the Trip Calculator to generate a transaction(s) in the form of the policy and a smart contract in a Contract Manager. Further, the processing device may be configured for adding the TCDC corresponding to the payment alert to the digital wallet of the Road User. Further, the processing device may be configured for adding the TCDC to a digital wallet of a Facility Owner account/address based on the policy and smart contract to generate the transfer alert. Further, the Facility Owner account may be associated with the at least Facility Owner. Further, the transfer alert may notify the at least one Facility Owner of receiving of the TCDC corresponding to the policy and smart contract, using the Road Ledger℠, a DLT network.

As seen in FIG. 2, the system may include a storage device configured for retrieving the Coin Manager data including cost values from the RUC Rates database, the Trip Manager data including digital map data, and the Trip Calculator data. Accordingly, the functionalities of the storage device may comprise the following. The storage device may be configured for retrieving the RUC Rates from RUC Rates database. In the preferred embodiment, the Trip Calculator data may include a machine learning model configured for determining a total cost for the trip. Further, the digital map data may include a geographical representation of a locality (such as city, province, country and, etc.). Thus, the storage device may be configured for storing the user data, the user account, the distance data, the cost data, the policy and smart contract, the payment alert, and the transfer alert on a DLT network.

In order to authenticate the various transactions, the system comprises verification process. Thus, according to the preferred embodiment, the method further comprises a step of transmitting verification of the identity of the at least one Facility Owner device, using the communication device. Further, the method comprises receiving, verification of identity and transaction in the form of the payment alert based on the policy and smart contract from the at least one Facility Owner device, using the communication device.

A more detailed description of the Trip Exchange platform follows. To accomplish step F and step G of the overall method, the system requires creating the Road User account and the Facility Owner account on the Trip Exchange platform. Accordingly, the at least one Road User may exchange currency for TCDCs in the Trip Exchange platform. In other words, the Trip Exchange platform may be used to convert fiat currency to digital currency, and to create TCDC (i.e., coins and tokens) etc. Thus, according to the preferred method, the TCDCs from the Trip Exchange platform may be transferred to a digital wallet of the at least one Road User account, as well as TCDCs from the digital wallet of the Facility Owner account may be transferred to the Trip Exchange platform. Further, TCDCs from the Trip Exchange platform may be exchanged for fiat currency and other digital currency by the Facility Owner. Thus, the TCDCs created in the Trip Exchange platform are stored in digital wallets of the at least one Road User account and the at least one Facility Owner account.

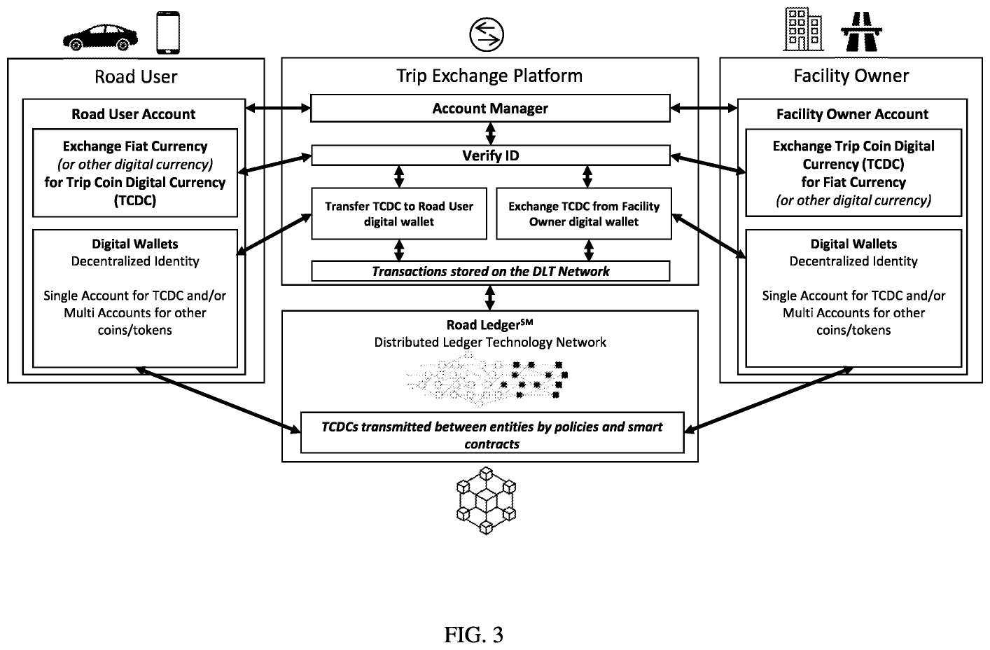

FIG. 3 is a schematic of a system for facilitating collecting RUC by the exchange of fiat currency and other digital currency, referred to as TCDC, and transferring TCDC between Road Users and Facility Owners based on a DLT network, in accordance with some embodiments. As seen in FIG. 3, a Road User may exchange fiat currency (i.e., USD, Euro, etc.) and other digital currency for TCDC, as well as the Facility Owner may exchange TCDC for fiat currency and other digital currency, in a Trip Exchange platform account manager. The TCDC may be used as the asset to be transacted on a Road Ledger℠, a DLT network. Further, the Road Users and the Facility Owners (or the Facility Owner) may create accounts on the Trip Exchange platform. Further, the Road Users and Facility Owners have digital wallets with accounts/address to hold digital currency (i.e., coins and tokens). Preferably, the Road User and Facility Owners may be verified using a decentralized identity technology. Further, the digital wallets may store the TCDC created in the Trip Exchange platform. Further, the TCDC may be transferred from the Trip Exchange platform to a digital wallet of the Road User. Further, the TCDC may be exchanged using a DLT network (includes, but not limited to, using a Directed Acyclic Graph known as a “Tangle”, a Hyperledger, and Blockchain, etc.). Further, the DLT network may be called the Road Ledger℠ that manages and maintains the transaction(s) for RUC (e.g., Vehicle Miles Traveled (VMT); Mileage-Based User Fee (MBUF), Road-use Charges, etc.). Further, the TCDC may be transferred from Road User digital wallets, by a policy and smart contract (which could be a hybrid smart contract), using the Road Ledger℠, a DLT network, to the respective Facility Owner digital wallets. Further, the Facility Owner may transfer TCDC from a digital wallet of the Facility Owner to the Trip Exchange platform.

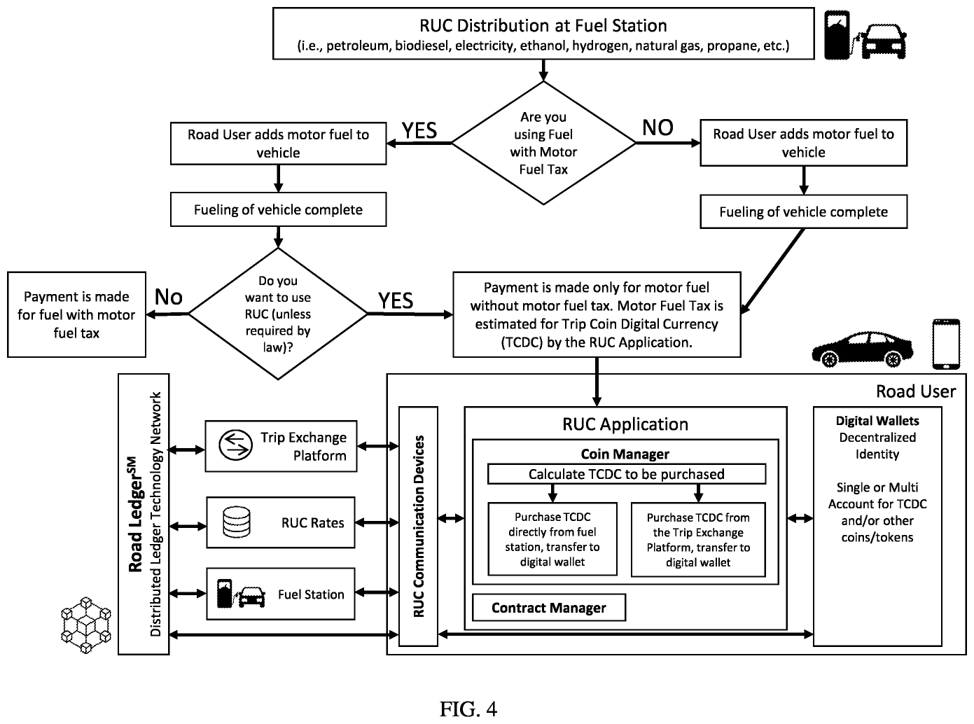

In reference to FIG. 4, a flow diagram of the method for facilitating adding TCDC to the Road User digital wallet at a fueling station, in accordance with some embodiments is illustrated. The fuel stations may include both commercial vendors (i.e., Gas Stations, Charging Stations, and etc.) and private on-grid and off-grid fuel stations (i.e., personal solar panel charging, home electrical charging and, etc.). Accordingly, the method commences when a Road User vehicle arrives at a fueling station to add motor fuel (i.e., petroleum, biodiesel, electricity, ethanol, hydrogen, natural gas, propane etc.). Further, at the fueling station, a Road User vehicle owner associated with petroleum-powered vehicles (any vehicle) may choose to pay motor fuel tax or participate in RUC at the fuel station. Road Users that participate in RUC will not pay the motor tax and use TCDC to pay for Road Use. Further, the RUC Application (or software platform) Coin Manager associated with the disclosed system may estimate the number of TCDC required based current balance of TCDC in Road User digital wallet and the estimated range of the motor fuel added to the vehicle and historical data from past trips. Further, the RUC Application Coin Manager and Contract Manager can also directly purchase TCDC from the fuel station, using a DLT network, after fuel has been added to the vehicle included in final payment. Further, fueling stations that cannot provide TCDC and are private on-grid or off-grid stations, the RUC Application Coin Manager and Contract Manager may connect to the Trip Exchange platform account manager wirelessly to purchase additional TCDC (i.e., coins and tokens). Further, TCDCs may be purchased in exchange for fiat currency. Further, the TCDC may be transferred to the digital wallet of the Road User after the identity is verified. All transactions are added to the Road Ledger℠, a DLT network.

Thus, according to the present invention, the functionality of the Coin Manager comprises calculating number of TCDCs required when adding motor fuel, connecting to the Trip Exchange platform to purchase TCDCs and accept pre-paid tokens from fuel station with the Contract Manager, and connecting to an RUC Rates database that maintains Facility Owner account information and the cost for each road facility may include different pricing models such as stable pricing, variable pricing, and dynamic pricing based on distance of travel and vehicle type which is set by the Facility Owner.

A more detailed description of the RUC Application with the help of a flow diagram follows.

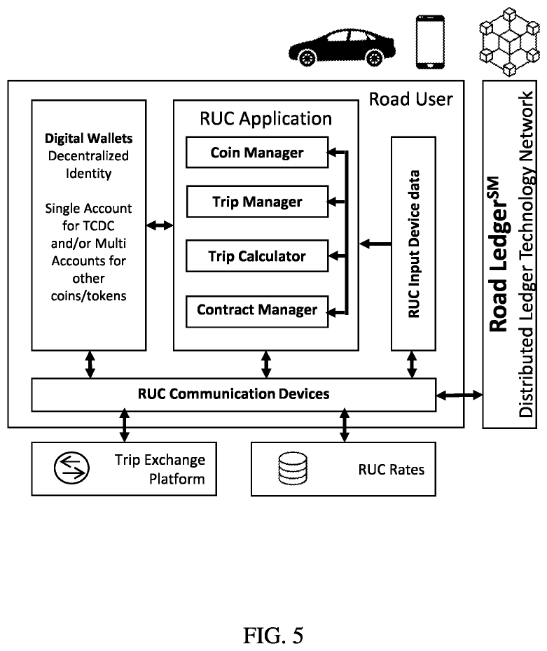

FIG. 5 is a flow diagram of a method for facilitating generating transaction(s) of TCDC in the form of policies and smart contracts to the Road Ledger℠, a DLT network for facilitating the collecting of the RUC, in accordance with some embodiments. Accordingly, the RUC Application may be hosted onboard a vehicle or on a mobile device. Further, the Coin Manager associated with the RUC Application may enable the estimation of tokens needed when fuel is added. Further, the Coin Manager may connect to the exchange to process a transfer fiat currency for TCDC. Further, the RUC Rates database associated with the RUC Application may host all the costs for each roadway. Further, the RUC Rates database, stored on the network, may provide the cost for each vehicle type for each roadway. The cost of each roadway may be managed by the Facility Owner and posted here to support the Road Use Calculator for processing the cost of the roadway. Further, the Coin Manager associated with the RUC Application may capture the routes taken on a trip and break them into segments. A segment is part of a trip where the Facility Owner remains constant during the trip. The Coin Manager may collect the distance traveled to be used in a policy and smart contract. Further, the Trip Calculator prepares the total cost for the policy and smart contracts. Further, the Contract Manager associated with the RUC Application may prepare the policy and smart contracts for each segment of the trip and use the TCDC to post on the Road Ledger℠, a DLT network.

To accomplish the above-mentioned functionalities, the RUC Application is installed on-board on a vehicle platform or installed on a mobile device to manage TCDC distribution. The RUC application further comprises a Coin Manager, a Trip Manager, a Trip Calculator, and a Contract Manager.

As previously mentioned, the RUC Application associated with the disclosed system may be installed on-board a vehicle platform or installed on a mobile device to manage RUC distribution. Further, the RUC Application may include a Graphical User Interface for the Road User to interface with application. Further, the RUC Application uses the Coin Manager and the Trip Calculator to estimate number of TCDC required when adding motor fuel. Further, the RUC Application uses the Coin Manager to connect to Trip Exchange platform to purchase TCDC or accept pre-paid tokens from fuel station, using a DLT network, and transfer TCDC to the digital wallet of the Road User.

Further, the Coin Manager may connect to a RUC Rates database that maintains Facility Owner account/address information and the rates/prices for each road facility which may include different pricing models such as stable pricing, variable pricing, and dynamic pricing based on distance of travel, type of vehicle and other system level attributes that may be set by the Facility Owner and provides information to the Trip Manager. Further, the Trip Manager may determine location of vehicle, identify the Facility Owners which the vehicle is operating on using digital maps or other means, maintain trip information based on segments, collect distance of travel data from available RUC Input Device data (i.e. Global Positioning System (GPS) data, Inertial Measurement Unit (IMU) data, odometer data, digital map data, on-board unit data, C-V2X data, cellular data, satellite data, and etc.).

In the preferred embodiment, the RUC Application uses the Trip Calculator to manage the cost for using each facility based on data from Trip Manager and the Coin Manager. The Trip Calculator prepares the transaction(s) to be provided to the Contract Manager at the completion of a segment and trip. Further, the RUC Application uses the Contract Manager to execute transaction(s) of TCDC, that may be stored in the Road User digital wallet, from the Trip Calculator for each Segment and trip on the Road Ledger℠ (Distributed Ledger Network). The Contract Manager connects using the communication device (i.e., Wi-Fi, OBU, DSRC, CV2X, Cellular (4G, LTE, 5G, 6G), Satellite, RFID and, etc.) to connect to Road Ledger℠, a DLT network. The Contract Manager wirelessly connects to the Road Ledger℠, a DLT network, through the cloud computing, fog computing or edge computing to process transaction(s) on the distributed network. The Road Ledger℠, a DLT network, supports online transaction(s) and off-line peer-to-peer transaction(s) at the edge computing level along the roadside.

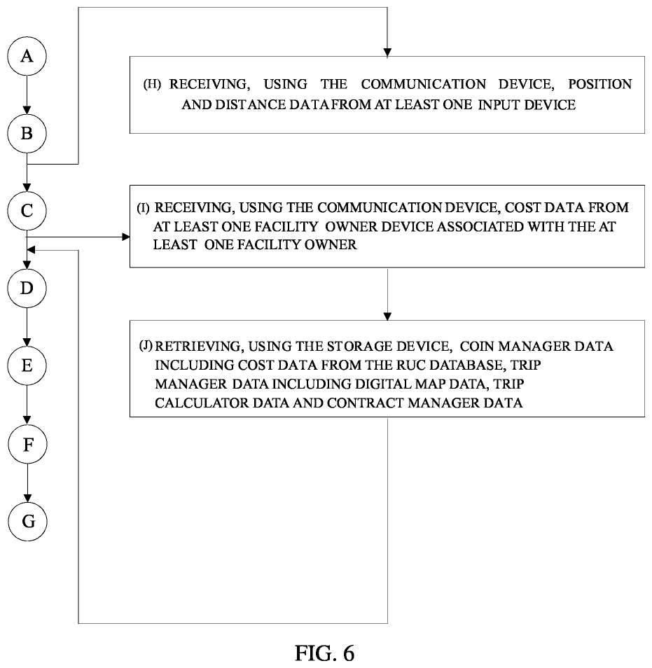

In reference to FIG. 6, a sub-process of the overall method is depicted, the sub-process comprising the step of receiving distance data from at least one input device, using the communication device (step H). Preferably, the distance data may be associated with a trip that may be characterized by a trip distance, trip route, etc. As seen in FIG. 6, after step C of the overall method, the sub-process comprises receiving cost data from the at least one Facility Owner device associated with the at least one Facility Owner, using the communication device (step I). Preferably, the cost data may include a cost for each vehicle type for each roadway associated with the Facility Owner. Furthermore, the sub-process continues by retrieving Coin Manager data (including cost values from the RUC Rates database, and digital map data, etc.), and Trip Calculator data, using the storage device (step J).

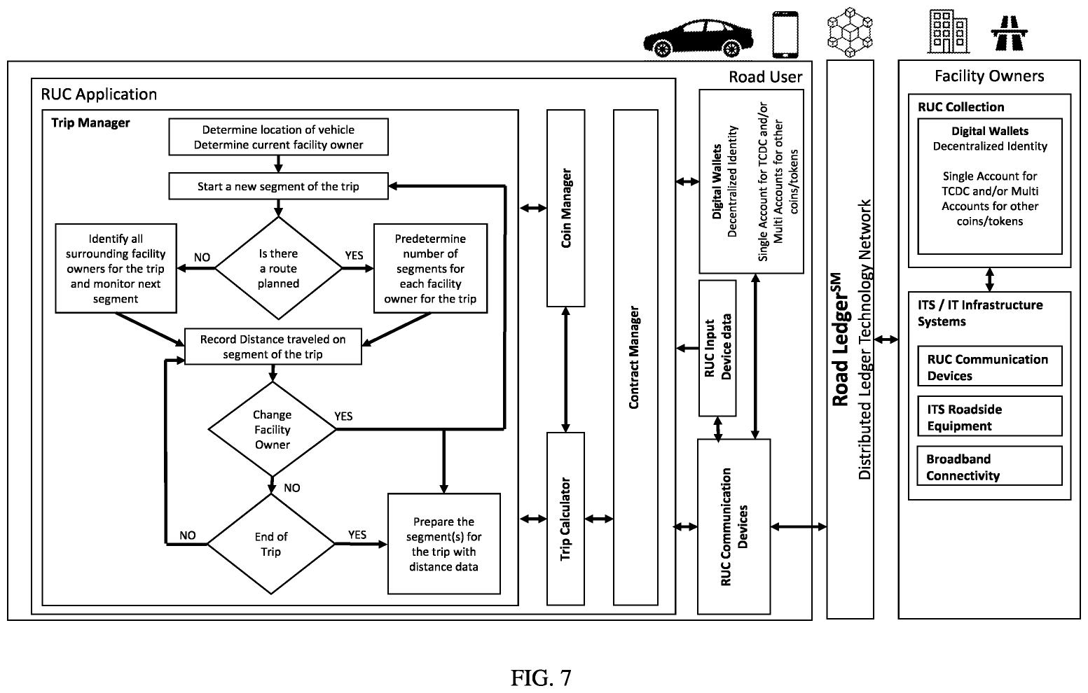

In reference to FIG. 7, a flow diagram of a method for facilitating and generating TCDC based on Facility Owners during a Road User trip determined by segments for facilitating the collecting of the RUC, in accordance with some embodiments is illustrated. Accordingly, a trip may be defined as the start and end of a specific route taken on the roadway network. Further, the disclosed system may be configured for determining a start location of the vehicle and the current Facility Owner to start a first segment. The vehicle may follow a route or monitor nearby Facility Owners for no pre-planned driving. The trip may be broken into one or more segment(s). A segment is where the Facility Owner remains constant during the trip. As the Facility Owner changes, a new segment is started. The Trip Manager may also collect the distance traveled to be used in a policy and smart contract by the Contract Manager. Once a segment is completed then the Contract Manager collects required data from Coin Manager, Trip Manager, and Trip Calculator, to meet the conditions of a policy and smart contract on the Road Ledger℠, a DLT network, for Road Use of the vehicle.

More specifically, the Trip Manager (described in FIG. 7) associated with the RUC Application may capture the routes taken on a trip and break them into segments. A segment is part of a trip where the Facility Owner remains constant during the trip. The Trip Manager may collect the distance traveled to be used in a policy and smart contract by the Contract Manager. Thus, according to the preferred embodiment, the method comprises, determining the location of a vehicle and current Facility Owner using data from RUC input device data by the Trip Manager, determining the start of a segment by the Trip Manager, determining whether the trip is planned or not planned with pre-selected route by the Trip Manager, and recording distance data for each segment of a trip by the Trip Manager.

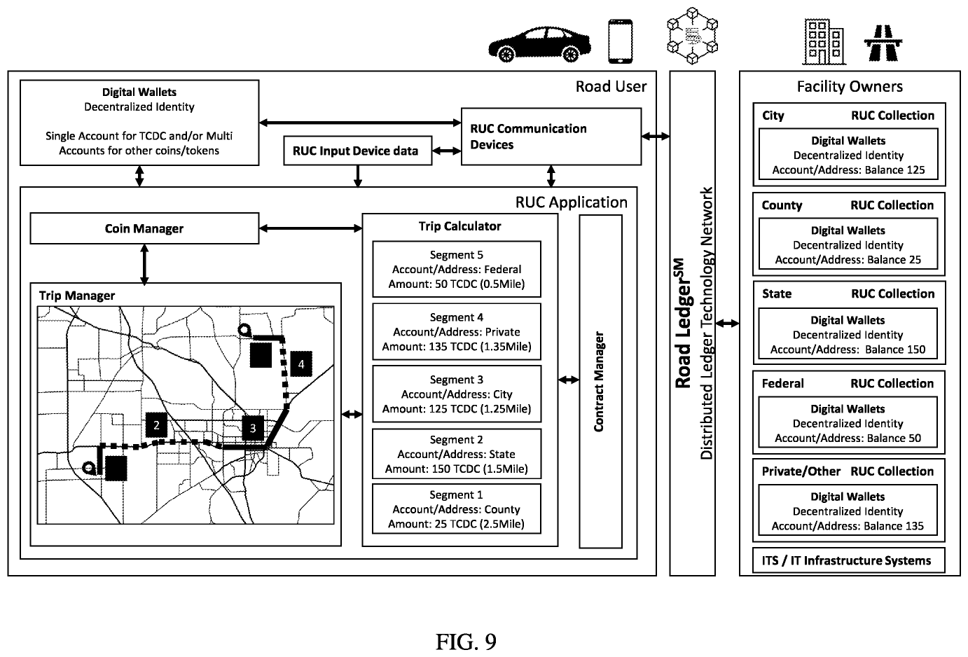

In the preferred embodiment, the Trip Calculator (described in FIG. 9) prepares the total cost and processes the cost of each roadway segments to later be used by the Contract Manager. Accordingly, the method of the present invention comprises managing the cost for using each facility based on data from the Coin Manager through the RUC Rates database wherein the Trip Calculator uses input from the Trip Manger to prepare all the data needed to support transactions for the Contract Manager for each segment owned by a different Facility Owner. Further, the Trip Calculator gathers Facility Owner account/address information form the Coin Manager through the RUC Rates database for each segment provided by the Trip Manager and determines the number of TCDCs to be provided to the Facility Owners based RUC Rates for each transaction.

Continuing with the preferred embodiment, the Contract Manager associated with the RUC Application may prepare the policy and smart contract and required data to meet conditions for each segment of the trip and use the TCDC for payment of Road Use to post on the Road Ledger℠, a DLT network. To that end, the method comprises executing transaction of TCDCs, which are stored in the Road User digital wallet, from the Trip Calculator for each segment of a trip on Road Ledger℠, a DLT network, using the Contract Manager. The method further comprises logging all transactions from the at least one Road User using the Road Ledger℠, a DLT network, for auditing purposes.

Further, the RUC Application uses the Trip Manager to determine the location of the vehicle and current Facility Owner using data from RUC input device data. Further, the Trip Manager may determine the start of a segment. Further, the Trip Manager may determine whether the trip is planned or not planned with pre-selected route. Further, the Trip Manager may record the distance data for each segment(s), where the Facility Owner is constant, along the trip until the completion of the trip, and transfer this data to the Trip Calculator. Further, the Contract Manager may execute transaction(s) of TCDC, that may be stored in the Road User digital wallet, from the Trip Calculator for each segment and trip on the Road Ledger℠, a DLT network. Further, the Contract Manager connects using a communication device (i.e., Wi-Fi, OBU, DSRC, CV2X, Cellular (4G, LTE, 5G, 6G), Satellite, RFID, and etc.) to the Road Ledger℠, a DLT network. Further, the Facility Owner may connect to the Road Ledger℠, a DLT network, through ITS/IT infrastructure systems (which may include wireless communication devices, ITS roadside equipment, broadband connectivity and etc.) to connect Facility Owner digital wallet. Further, the Facility Owner receives the TCDC directly to a digital wallet from the Road User for each segment and trip using Road Ledger℠, a DLT network.

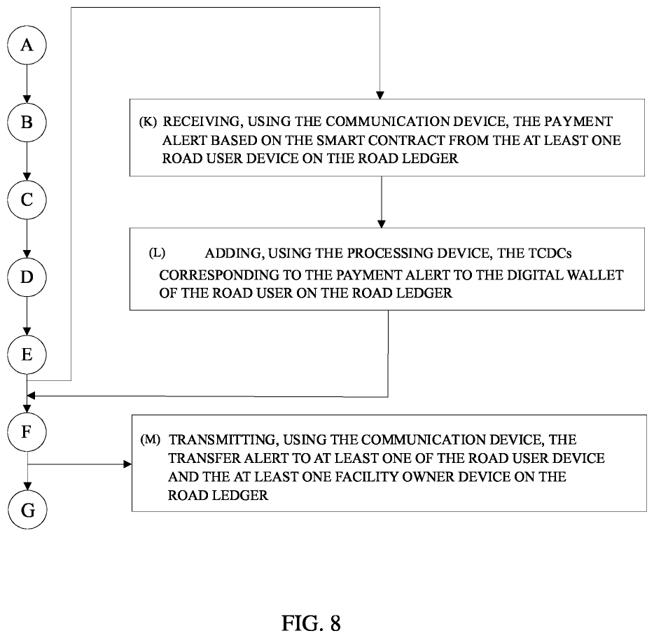

In reference to FIG. 8, a sub-process of the overall method is depicted, wherein the sub-process includes, receiving a payment alert based on the policy and smart contract from the at least one user device, using the communication device (step K). The payment alert may include a consent from the at least one user to pay for the total cost. Subsequently, the sub-process continues by adding the TCDCs corresponding to the payment alert to the digital wallet of the user, using the processing device (step L). The receiving of the payment alert may include receiving of funds (or money, coins, tokens, digital currency, etc.) equivalent to the total cost. The sub-process further comprises a step of transmitting the transfer alert to at least one of the at least one user device and the at least one Facility Owner device, using the communication device (step M). The transfer alert may notify the at least one Facility Owner of receiving of the TCDC corresponding to the policy and smart contract.

In reference to FIG. 9, is a flow diagram of a method for facilitating generating transaction(s) of TCDC by segments of a trip based on Facility Owners for facilitating the collecting of the RUC, in accordance with some embodiments is illustrated. Accordingly, each segment may be transmitted to the appropriate Facility Owner through a policy and smart contract on the Road Ledger℠, a DLT network. Further, each policy and smart contract may include the TCDC attached as payment of road use on the facility. According to the preferred embodiment, road owners and operators may be separated into different categories (i.e., Federal, State, County, City, Private, other and etc.). Further, each road owner may have their account/unique ID and will act as a Node in the Road Ledger℠, a DLT network (includes, but not limited to, using a Directed Acyclic Graph known as a “Tangle”, a Hyperledger, and Blockchain, etc.). Each of the facilities of the road owner may be linked to an account on the Road Ledger℠, a DLT network (i.e., a Tangle and etc.). Further, the facility owners can exchange the TCDC for fiat currency using the Trip Exchange platform account manager. Further, TCDC distribution is based on the vehicle route and which facilities are used during the trip. Further, a digital map may be used with a control layer that may be used to link facilities to accounts/address on the Road Ledger℠, a DLT network (i.e., a Tangle and etc.) with the Facility Owner. Further, each entity/vehicle may use the distance traveled on each road facility as a means of distributing TCDC via a policy and smart contract. Further, the policy and smart contract may be generated to transact TCDC to the appropriate Facility Owner. Further, each policy and smart contract may execute after exiting a road facility (i.e., when road Facility Owners change) or at the end of a trip. This may be defined by the Road Ledger℠, a DLT network, that will manage the TCDC transaction(s). If there is no connectivity, the vehicle or mobile device may store the transaction(s) on-board until connectivity is available to make the transaction(s). Further, the Coin Manager may break the trip into different segments based on the Facility Owner (i.e., Federal, State, County, City, Private, etc.). Further, the Coin Manager may be configured for receiving the RUC Rates, that define the cost for each road facility may include different pricing models such as stable pricing, variable pricing, and dynamic pricing based on distance of travel and vehicle type. Further, the Trip Calculator may prepare all the transaction(s) for the Contract Manager for each segment owned by a different Facility Owner. Further, the Trip Calculator gathers account/address information from the Coin Manager through the RUC Rates database for each segment. Further, the Trip Calculator determines the number of TCDC based RUC Rates (i.e., distance and vehicle type rates/cost) for each transaction(s). Further, the Contract Manager may execute transaction(s) of TCDC, which are stored in the digital wallet of the Road User and for each Segment and trip provided by Trip Calculator, on the Road Ledger℠, a DLT network. Further, the Contract Manager may log all transaction(s) form the Road User using on-board storage device and the Road Ledger℠, a DLT network for auditing purposes. Further, the Facility Owner receives the TCDC directly to the digital wallet of the Facility Owner from the Road User for each segment and or trip using the Road Ledger℠, a DLT network. Further, the Facility Owner may transfer TCDC from their digital wallet to the Trip Exchange platform. Further, the Facility Owner may exchange the TCDC for fiat currency or other digital currency in the Trip Exchange platform.

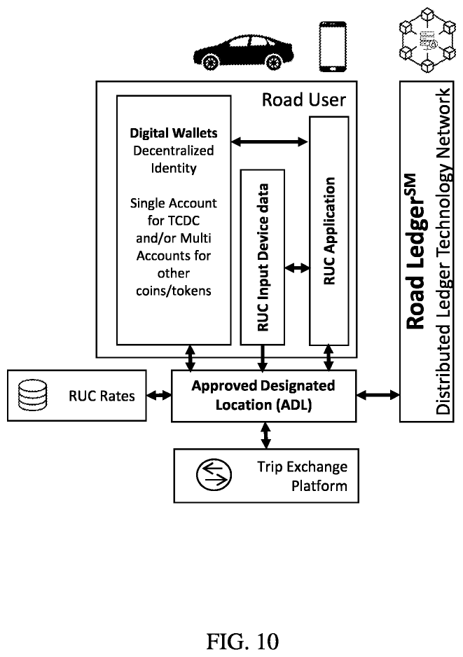

In reference to FIG. 10, is a flow diagram of a method for facilitating RUC at an Approved Designated Location (ADL), in accordance with some embodiments is illustrated. Accordingly, Road Users that do not have a communications device can transact their RUC stored on the RUC Application and report their mileage directly from their RUC input devices, for any vehicle, at an Approved Designated Location (ADL) (i.e., Department of Motor Vehicles (DMV), Inspection center, private organization, etc.). Further, the Road Users may report to the ADL based on any required frequency (i.e., monthly, bi-annually, annually, etc.). Further, the RUC pricing model based on reporting frequency (monthly, bi-annually, annually, etc.) may be provided by the RUC Rates database and may include a distribution model for RUC to the designated Facility Owner accounts (i.e., federal, state, city, county, other, etc).

Further, the Road Users with a RUC Application may provide their data, for a specific reporting period, to the ADL used to transact RUC. Further, the ADL may create a policy and smart contract for the Road User. Further, the Road User will link their digital wallet to the policy and smart contract created by the ADL to transact TCDC for RUC to be stored on the Road Ledger℠, a DLT network.

Further, the Road Users without a RUC Application may report their total road use distance (i.e., miles, kilometers, etc.), for a specific reporting period, to the ADL used to transact RUC. Further, the ADL may create a policy and smart contract for the Road User. Further, the Road User will link their digital wallet to the policy and smart contract created by the ADL to transact TCDC for RUC to be stored on the Road Ledger℠, a DLT network. Further, the ADL may connect to the Trip Exchange platform, for Road Users that do not have a digital wallet, to exchange any fiat and other digital currency for TCDC to be used in the policy and smart contract to transact TCDC for RUC to be stored on the Road Ledger℠, a DLT network.

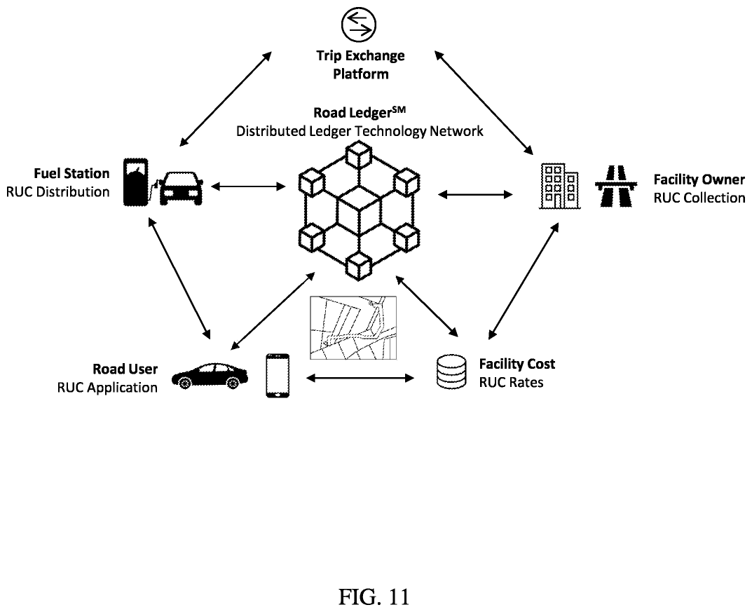

In reference to FIG. 11, an overall representation of the system of the present invention is depicted. In other words, FIG. 11 is a schematic of a system for facilitating the collecting of the RUC using a digital currency based on a DLT network, in accordance with some embodiments. Accordingly, the system may be associated with the Road Ledger℠, a DLT network. Further, the fueling station may be communicatively coupled to the system (or the DLT network). Further, the fueling station may facilitate TCDC distribution to a digital wallet of a Road User (or a driver). Further, the Road User may use a RUC Application software on-board a vehicle or mobile device. Further, the RUC Application may facilitate executing RUC policies and smart contracts based on trip segments. Further, the system may include an RUC Rates database configured for storing the road facility cost which may include different pricing models such as stable pricing, variable pricing, and dynamic pricing based on distance of travel and vehicle type set by the Facility Owner. Further, the Facility Owners (e.g., IOOs) may collect the TCDC from policies and smart contracts executed on the Road Ledger℠, a DLT network.

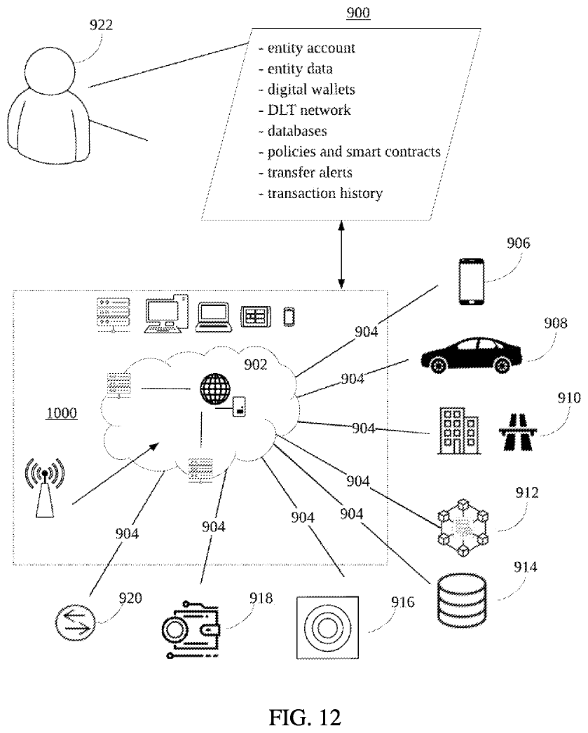

FIG. 12 is an illustration of an online platform 900 consistent with various embodiments of the present disclosure. By way of non-limiting example, the online platform 900 for facilitating the collecting of the RUC using a digital currency based on a DLT network may be hosted on a centralized and decentralized server 902, such as, for example, an on-prem, cloud, fog or edge computing (i.e., MEC) service. The centralized and decentralized server 902 may communicate with other network entities, such as, for example, a mobile device 906 (such as a smartphone, a laptop, a tablet computer, etc.), an on-board vehicle device 908 (such as electronic control units, connected vehicle platforms, automated driving system platforms, telematic systems, and etc.), roadway facility owners infrastructure devices 910 (such as Intelligent Transportation Systems (ITS) and Information Technology (IT) systems including but not limited to RUC Communication, ITS Roadside Equipment, Broadband Connectivity, owned and operated by city, county, state, federal, private/other, etc.), other electronic devices 912 (such as distributed desktop computers, server computers, edge computers that form a networks, etc.), databases 914, sensors 916, digital wallets 918 (including but not limited to software and hardware wallets), digital currency exchange platforms 920, (online network), 904, such as, but not limited to, the Internet. Further, users of the online platform 900 may include relevant parties such as, but not limited to, end-users, service providers, and administrators. Accordingly, in some instances, electronic devices operated by the one or more relevant parties may be in communication with the online platform 900. A user 922, such as the one or more relevant parties, may access the online platform 900 through a web-based software application or browser (including but not limited to web 2.0 and web 3.0). The web-based software application may be embodied as, for example, but not be limited to, a website, a web application, a desktop application, a mobile application, on-board vehicle application, roadside application, compatible with a computing device 1000.

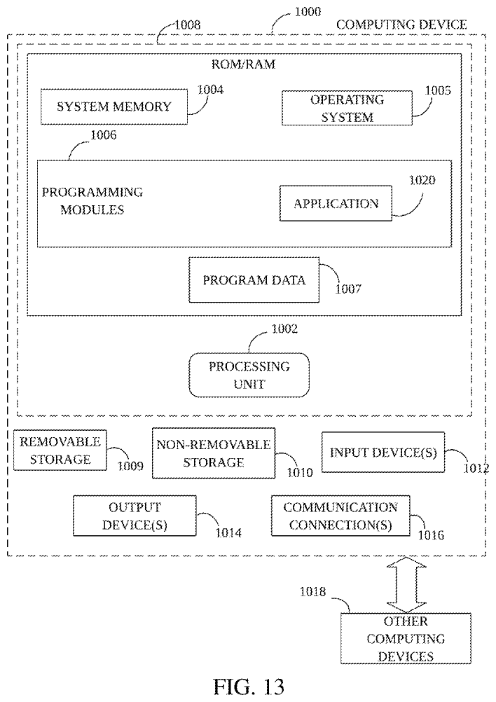

With reference to FIG. 13, a system consistent with an embodiment of the disclosure may include a computing device or cloud, fog or edge service, such as computing device 1000. In a basic configuration, computing device 1000 may include at least one processing unit 1002 and a system memory 1004. Depending on the configuration and type of computing device, system memory 1004 may comprise, but is not limited to, volatile (e.g., random-access memory (RAM)), non-volatile (e.g., read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module and image classifying module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and non-removable) such as, for example, magnetic disks, optical disks, or tape. Such additional storage is illustrated in FIG. 13 by a removable storage 1009 and a non-removable storage 1010. Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include and not limited to the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Thus, an overall overview of the present invention may be described as follows: The process for creating digital currency to facilitate and collect for Road User Charges using on the distributed ledger network. An Entity may create an account in the Trip Exchange platform. Road User to connect at least one digital wallet including the digital wallet used for at least one vehicle to the account in the Trip Exchange platform. Facility Owners to connect at least one digital wallet including the digital wallet used for at least one roadway (i.e., segment) to the account in the Trip Exchange platform. Further, entities must verify ID (e.g., distributed identity technology) to access account in the Trip Exchange platform. Further, Road User connects to Trip Exchange platform to purchase Trip Coin℠ Digital Currency (TCDC) (i.e., stable coin, utility tokens, etc.) using fiat currency and other digital currency which may or may not include a service fee. Further, Trip Exchange platform to process an exchange of fiat currency and other digital currency to the digital wallet of the Road User for TCDC which may or may not include a service fee, stored on the Road Ledger℠, a DLT network. Further, TCDCs are stored in a Road User digital wallet to be used for Road User Charges (RUC), also known as Road Tax. Further, Road User to transfer TCDCs to facility owner(s) digital wallets using a policy and smart contract using the Road Ledger℠, a DLT network, which may or may not include a service fee. Further, store the TCDCs in a Facility Owner digital wallet for collection of Road User Charges. Further, entity must verify ID to access account in the Trip Exchange platform. Further, Facility Owner process an exchange of TCDC for fiat currency and other digital currency using the Trip Exchange Platform which may or may not include a service fee.

The process for adding the TCDC to a vehicle digital wallet when at the fuel station comprises the following steps. Road User connects to the digital wallet used in at least one vehicle to the account created in the Trip Exchange platform. Further, Road User adds motor fuel at fueling station to at least one vehicle. Further, Road User(s) have two options to pay motor fuel tax. First, Road User choses to pays the motor fuel tax as part of the sale of the motor fuel (existing method). For example, petroleum-based motor fuel includes tax based on cost per gallon or liter paid at the fueling station, which excludes participation in a Road Use Charging (RUC) structure. Second, Road User purchases TCDCs in place of motor fuel tax to be distributed to the facility owners for the roadways which the vehicle will use as part of a trip (present invention). For example, the TCDCs will enable a Road User Charges structure based on distance of travel that will transform roadway financing. More specifically, Road User can purchase TCDCs from the fuel station or directly from the Trip Exchange Platform by the RUC Application using the Coin Manager and Contract Manager may use the Road Ledger℠, a DLT network

Furthermore, Road Users may purchase the TCDCs from a Fuel Station (i.e., commercial motor fuel station). Further, Fuel Station Owner issues a policy and smart contract to the Road User with the conditions for the sale of TCDCs, posted on the distributed ledger network. Further, The Road User Contract Manager verifies the policy and smart contract conditions. Further, upon completing the addition of motor fuel, the Coin Manager calculates the estimated TCDCs based on data from the RUC Database which also includes but not limited to input device data and historical data from Trip Manager and Trip Calculator the vehicle storage device using artificial intelligence/machine learning algorithms. Further, the Contract Manager uses data from the Coin Manager, Trip Manager, Trip Calculator to add the required information to the Smart Contract to trigger an automated execution of the policy and Smart Contract on the distributed ledger network. Further, fuel station Owner transfers TCDCs from the Fuel Station digital wallet to the Road User digital wallet upon successful execution of policy and smart contract stored on the Road Ledger℠, a DLT network, to be used for Road User Charges.

Furthermore, Road Users may not have option to purchase the TCDCs from a Fuel Station (i.e., home charging station). Further, upon completing the addition of motor fuel, the Coin Manager calculates the estimated TCDCs based on data from the RUC database which also includes but not limited to input device data and historical data from Trip Manager and Trip Calculator the vehicle storage device using artificial intelligence/machine learning algorithms. Further, Trip Application Contract Manager connects to Trip Exchange platform to purchase TCDC using fiat currency and other digital currency which may or may not include a service fee. Further, Trip Exchange Platform to process an exchange of fiat currency and other digital currency to the digital wallet of the Road User for TCDC which may or may not include a service fee, stored on the Road Ledger℠, a DLT network. Further, Road User receives TCDCs which are stored in a Road User Digital Wallet to be used for Road User Charges.

The process for transferring TCDCs from Road Users to Facility Owners for the collection of Road User Charges using the Road Ledger℠, a DLT network, k comprises the following steps. Road User starts the vehicle and the RUC Application Trip Manager using communication and input device data to determine the current location and current facility owner. Further, Road User RUC Application Trip Manager starts a new segment of the trip and determines if this trip is planned or not planned. Further, Road User RUC Application Coin Manager using communication devices connects to the RUC rates database to obtain the cost data and account/address for each facility owner. Further, Road User RUC Application Contract Manager pulls the policy and smart contracts for each segment stored on the Road Ledger℠, a DLT network. Further, Road User RUC Application Contract Manager provides the conditions from the policy and smart contract required data to Trip Manager and Trip Calculator Further, Road User RUC Application Trip Manager records the position and distance data, geographic data and other data from input devices for each segment for a single trip and provide data to Trip Calculator. Further, Road User RUC Application Trip Calculator uses input data from Trip Manager and Coin Manager to calculate the cost in TCDCs for each segment of the trip. Further, More specifically, Road User RUC Application Contract Manger uses the data from the Trip Calculator to prepare input data in the form of conditions to the policy and the Smart Contracts between Road Users and Facility Owners. Further, The RUC Application Contract Manager receives, using communication device, a policy and smart contract from a Facility Owner which includes the account/address and conditions for each new segment. Further, RUC Application Contract Manger, upon completing the segment and the trip, will compile the required data elements to meet the conditions of the policy and smart contract. Further, RUC Application Contract Manager process data from the Coin Manger, Trip Manager, Trip Calculator to add the required data elements or conditions, such as but not limited to distance of travel, amount of TCDCs, etc. to trigger an automated execution of the policy and smart contract on the Road Ledger℠, a DLT network. Further, Road User transfers TCDCs which are stored in a Road User digital wallet to be used for Road User Charges to the Facility Owner digital wallet based on the policy and smart contract stored on the Road Ledger℠, a DLT network.

Embodiments of the present disclosure, for example, are described above with reference to block diagrams and operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and inserting or deleting stages, without departing from the disclosure.

What is claimed is:

1. A method for facilitating the collecting of the Road user charge (RUC) using a digital currency based on a Distributed Ledger Technology (DLT) network, the method comprising the steps of:
(A) receiving, using a communication device, Road User data from at least one Road User device associated with at least one Road User and Facility Owner data from at least one Facility Owner device associated with at least one Facility Owner;
(B) processing, using a processing device, the Road User data to generate a Road User account, and the Facility Owner data to generate a Facility Owner account;
(C) retrieving, using a storage device, Trip Coin℠ Digital Currency (TCDC) to a Road User digital wallet from at least one of a fueling station and a Trip Exchange platform;
(D) analyzing, using the processing device, data from an RUC Application to generate a transaction of TCDC in the form of at least one of a policy and the smart contract on the Road Ledger℠, a DLT network;
(E) transmitting, using the communication device, the transaction of TCDC in the form of the at least one of the policy and the smart contract to the at least one Road User device and the at least one Facility Owner device through the Road Ledger℠, a DLT network;
(F) adding, using the processing device, the TCDCs to a facility digital wallet of the Facility Owner account based on at least one of the policy and the smart contract to generate a transfer alert; and
(G) storing, using the storage device, the at least one of the policy and the smart contract, a payment alert, and the transfer alert on the Road Ledger℠, a DLT network.

2. The method for facilitating the collecting of the Road User Charges (RUC) using a digital currency based on a Distributed Ledger Technology (DLT) network, the method as claimed in claim 1 comprises the steps of:
creating the Road User account and the Facility Owner account on a Trip Exchange platform;
exchanging fiat currency for TCDCs in the Trip Exchange platform by the at least one Road User;
transferring TCDCs from the Trip Exchange platform to a digital wallet of the at least one Road User account;
transmitting TCDCs from the digital wallet of the at least one Road User to the digital wallet of at least one Facility Owner account in the form of at least one of the policy and the smart contract on the Road Ledger℠, a DLT network;
transferring TCDCs from the digital wallet of the at least one Facility Owner account to the Trip Exchange platform; and
exchanging TCDCs for fiat currency and other digital currency in the Trip Exchange platform by the at least one Facility Owner.

3. The method for facilitating the collecting of the Road User Charges (RUC) using a digital currency based on a Distributed Ledger Technology (DLT) network, the method as claimed in claim 1 comprises the steps of:
transmitting, using the communication device, verification of the identity for the at least one Facility Owner device; and
receiving, using the communication device, verification of identity and transaction in the form of a payment alert based on the policy and smart contract from the at least one Facility Owner device, on the Road Ledger℠, a DLT network.

4. The method for facilitating the collecting of the Road user charge using a digital currency based on a Distributed Ledger Technology (DLT) network, wherein the TCDCs created in the Trip Exchange platform are stored in digital wallets of the at least one Road User account and the at least one Facility Owner account.

5. The method for facilitating the collecting of the Road User Charges (RUC) using a digital currency based on a Distributed Ledger Technology (DLT) network, the method as claimed in claim 1 comprising the steps of:
(H) receiving, using the communication device, position and distance data from at least one input device, wherein distance data is from the RUC Application data;
(I) receiving, using the communication device, cost data from the at least one Facility Owner account associated with the at least one Facility Owner, wherein cost data is from the RUC Application data; and
(J) retrieving, using the storage device, Coin Manager data including cost data from an RUC database, Trip Manager data including digital map data, Trip Calculator data and Contract Manager data.

6. A method for facilitating the collecting of the Road User Charges (RUC) using a digital currency based on a Distributed Ledger Technology (DLT) network, the method as claimed in claim 1 comprises the steps of:
(K) receiving, using the communication device, the payment alert based on at least one of the policy and a smart contract from the at least one Road User device on the Road Ledger℠, a DLT network;
(L) adding, using the processing device, the TCDCs corresponding to the payment alert to the digital wallet of the Road User on the Road Ledger℠, a DLT network; and
(M) transmitting, using the communication device, the transfer alert to at least one of the at least one Road User device and the at least one Facility Owner device on the Road Ledger℠, a DLT network.

7. The method for facilitating the collecting of the Road User Charges (RUC) using a digital currency based on a Distributed Ledger Technology (DLT) network, the method as claimed in claim 1, comprising:
installing the RUC Application on a vehicle platform or on a mobile device to manage TCDC distribution; and
the RUC Application comprising a Coin Manager, Trip Manger, Trip Calculator, and a Contract Manager.

8. The method for facilitating the collecting of the Road User Charges (RUC) using a digital currency based on a Distributed Ledger Technology (DLT) network, the method as claimed in claim 6 comprising the steps of:
determining the location of a vehicle and current Facility Owner using data from RUC input devices using the Trip Manager;
determining the start of a segment using the Trip Manager;
determining whether the trip is planned or not planned with pre-selected route using the Trip Manager; and
recording position and distance data for each segment of a trip using the Trip Manager.

9. The method for facilitating the collecting of the Road User Charges (RUC) using a digital currency based on a Distributed Ledger Technology (DLT) network, the method as claimed in claim 6 comprises the steps of:
calculating number of TCDCs required when adding motor fuel using the Coin Manager;
connecting to a Trip Exchange platform to purchase TCDCs or accept pre-paid tokens from fuel station using the Coin Manager, on the Road Ledger℠, a DLT network; and
connecting to an RUC Rates database that maintains Facility Owner account information and the cost data for each road facility based on distance of travel, type of vehicle and other system level attributes which is set by the Facility Owner using the Coin Manager.

10. The method for facilitating the collecting of the Road User Charges (RUC) using a digital currency based on a Distributed Ledger Technology (DLT) network, the method as claimed in claim 6 comprising the steps of:
managing the cost for using each facility based on data from the Coin Manager and the Trip Manager using the Trip Calculator;
preparing all the transactions for the Contract Manager for each segment owned by a different Facility Owner using the Trip Calculator;
gathering account/address information form the Coin Manager through the RUC Rates database for each segment using the Trip Calculator; and
determining the number of TCDCs based RUC Rates database for each transaction using the Trip Calculator.

11. The method for facilitating the collecting of the Road User Charges (RUC) using a digital currency based on a Distributed Ledger Technology (DLT) network, the method as claimed in claim 6 comprising the steps of:
executing transaction of TCDCs, stored in the Road User digital wallet, from the Trip Calculator for each segment of a trip on the Road Ledger℠, a DLT network using the Contract Manager; and
logging all transactions from the at least one Road User using the Road Ledger℠, a DLT network for auditing purposes.

12. The method for facilitating the collecting of the Road User Charges (RUC) using a digital currency based on a Distributed Ledger Technology (DLT) network, the method as claimed in claim 6 comprises the steps of:
gathering data form the RUC Application and the RUC input device data at an Approved Designated Location (ADL);
connecting to a RUC Rates database for RUC pricing at an ADL;
calculating number of TCDCs required by Road User for RUC at an ADL;
preparing all the transactions for the Road User at an ADL;
connecting to the Trip Exchange platform to purchase TCDCs for Road Users without digital wallets; and
executing transaction of TCDCs, stored in the Road User digital wallet or from the ADL using on the Road Ledger℠, a DLT network.

13. A method for facilitating the collecting of the Road user charge using a digital currency based on a Distributed Ledger Technology (DLT) network, the method comprises the steps of:
(A) receiving, using a communication device, Road User data from at least one Road User device associated with at least one Road User and Facility Owner data from at least one Facility Owner device associated with at least one Facility Owner;
(B) processing, using a processing device, the Road User data to generate a Road User account, and the Facility Owner data to generate a Facility Owner account;
(C) receiving, using the communication device, position and distance data from at least one input device, wherein distance data is from the RUC Application data;
(D) retrieving, using a storage device, Trip Coin℠ Digital Currency (TCDC) to a Road User digital wallet from at least one of a fueling station and a Trip Exchange platform;
(E) receiving, using the communication device, cost data from the at least one Facility Owner account associated with the at least one Facility Owner, wherein cost data is from the RUC Application data;
(F) retrieving, using the storage device, Coin Manager data including cost data from an RUC database, Trip Manager data including digital map data, Trip Calculator data and Contract Manager data;
(G) analyzing, using the processing device, data from an RUC Application to generate a transaction of TCDC in the form of at least one of a policy and the smart contract on a Distributed Ledger Technology (DLT) network;
(H) transmitting, using the communication device, the transaction of TCDC in the form of the at least one of the policy and the smart contract to the at least one Road User device and the at least one Facility Owner device through the Road Ledger℠, a DLT network;
(I) receiving, using the communication device, the payment alert based on at least one of the policy and a smart contract from the at least one Road User device Road Ledger℠, a DLT network;
(J) adding, using the processing device, the TCDCs corresponding to the payment alert to the digital wallet of the Road User on the Road Ledger℠, a DLT network;
(K) adding, using the processing device, the TCDCs to a facility digital wallet of the Facility Owner account based on at least one of the policy and a smart contract to generate a transfer alert on the Road Ledger℠, a DLT network;
(L) transmitting, using the communication device, the transfer alert to at least one of the at least one Road User device and the at least one Facility Owner device Road Ledger℠, a DLT network; and
(M) storing, using the storage device, the at least one of the policy and the smart contract, a payment alert, and the transfer alert on the Road Ledger℠, a DLT network.

14. The method for facilitating the collecting of the Road User Charges (RUC) using a digital currency based on a Distributed Ledger Technology (DLT) network, the method as claimed in claim 13, comprises the steps of:
creating the Road User account and the Facility Owner account on an Trip Exchange platform;
exchanging fiat currency for TCDCs in the Trip Exchange platform by the at least one Road User;
transferring TCDCs from the Trip Exchange platform to a digital wallet of the at least one Road User account;
transmitting TCDCs from the digital wallet of the at least one Road User to the digital wallet of at least one Facility Owner account in the form of at least one of the policy and the smart contract on the Road Ledger℠, a DLT network;
transferring TCDCs from the digital wallet of the at least one Facility Owner account to the Trip Exchange platform; and
exchanging TCDCs for fiat currency and other digital currency in the Trip Exchange platform by the at least one Facility Owner.

15. The method for facilitating the collecting of the Road User Charges (RUC) using a digital currency based on a Distributed Ledger Technology (DLT) network, the method as claimed in claim 13, comprising:
installing the RUC Application on a vehicle platform or on a mobile device to manage TCDC distribution; and
the RUC Application comprising a Coin Manager, Trip Manger, Trip Calculator, and a Contract Manager.

16. The method for facilitating the collecting of the Road User Charge (RUC) using a digital currency based on a Distributed Ledger Technology (DLT) network, the method as claimed in claim 15, comprising the steps of:
determining the location of a vehicle and current Facility Owner using data from RUC input devices using the Trip Manager;
determining the start of a segment using the Trip Manager;
determining whether the trip is planned or not planned with pre-selected route using the Trip Manager; and
recording position and distance data for each segment of a trip using the Trip Manager.

17. The method for facilitating the collecting of the Road User Charges (RUC) using a digital currency based on a Distributed Ledger Technology (DLT) network, the method as claimed in claim 15, comprises the steps of:
calculating number of TCDCs required when adding motor fuel using the Coin Manager;
connecting to a Trip Exchange platform to purchase TCDCs or accept pre-paid tokens from fuel station using the Coin Manager, on the Road Ledger℠, a DLT network; and
connecting to an RUC Rates database that maintains Facility Owner account information and the cost data for each road facility based on distance of travel, type of vehicle and other system level attributes which is set by the Facility Owner using the Coin Manager.

18. The method for facilitating the collecting of the Road User Charges (RUC) using a digital currency based on a Distributed Ledger Technology (DLT) network, the method as claimed in claim 15, comprising the steps of:
managing the cost for using each facility based on data from the Coin Manager and the Trip Manager using the Trip Calculator;
preparing all the transactions for the Contract Manager for each segment owned by a different Facility Owner using the Trip Calculator;
gathering account/address information form the Coin Manager through the RUC Rates database for each segment using the Trip Calculator; and
determining the number of TCDCs based RUC Rates database for each transaction using the Trip Calculator.

19. The method for facilitating the collecting of the Road User Charges (RUC) using a digital currency based on a Distributed Ledger Technology (DLT) network, the method as claimed in claim 15, comprising the steps of:
executing transaction of TCDCs, which are stored in the Road User digital wallet, from the Trip Calculator for each segment of a trip on the Road Ledger℠ a DLT network using the Contract Manager; and
logging all transactions from the at least one Road User using the Road Ledger℠, a DLT network for auditing purposes.

20. The method for facilitating the collecting of the Road User Charges (RUC) using a digital currency based on a Distributed Ledger Technology (DLT) network, the method as claimed in claim 15, comprises the steps of:
gathering data form the RUC Application and the RUC input device data at an Approved Designated Location (ADL);
connecting to a RUC Rates database for RUC pricing at an ADL;
calculating number of TCDCs required by Road User for RUC at an ADL;
preparing all the transactions for the Road User at an ADL;
connecting to the Trip Exchange platform to purchase TCDCs for Road Users without digital wallets; and
executing transaction of TCDCs, stored in the Road User digital wallet or from the ADL using on the Road Ledger℠, a DLT network.
